(19) United States
(12) Patent Application Publication
(10) Pub. No.: US 2014/0283878 A1
(43) Pub. Date: Sep. 25, 2014

(54) NOZZLE CLEANING UNIT AND NOZZLE CLEANING METHOD

(71) Applicant: Kabushiki Kaisha Toshiba, Minato-ku (JP)

(72) Inventors: Kenichi OOSHIRO, Kanagawa-ken (JP); Tsuyoshi Sato, Kanagawa-ken (JP); Hiroaki Kobayashi, Kanagawa-ken (JP)

(73) Assignee: Kabushiki Kaisha Toshiba, Minato-ku (JP)

(21) Appl. No.: 14/025,938

(22) Filed: Sep. 13, 2013

(30) Foreign Application Priority Data
Mar. 21, 2013 (JP) 2013-059141

(51) Int. Cl. B05B 15/02

(52) U.S. Cl. CPC B05B 15/025
USPC 134/22.18; 15/316.1

(57) ABSTRACT

According to one embodiment, a nozzle cleaning unit includes: a cleaning nozzle unit; a gas supply unit; and a regulator. The cleaning nozzle unit has a first ejection hole that opens in a ring shape to an inner wall surface of an insertion part into which the nozzle is inserted. The gas supply unit supplies gas to the first ejection hole. The regulator reduces a pressure of an atmosphere of the insertion part on a side opposite a side in which the nozzle is inserted, sandwiching a position where the first ejection hole is provided.

### CROSS-REFERENCE TO RELATED APPLICATIONS

This application is based upon and claims the benefit of priority from Japanese Patent Application No. 2013-059141, filed on Mar. 21, 2013; the entire contents of which are incorporated herein by reference.

### FIELD

Embodiments described herein relate generally to a nozzle cleaning unit and a nozzle cleaning method.

### BACKGROUND

There are nozzle cleaning units that inject cleaning fluid to a nozzle to be cleaned, and then inject air for drying the nozzle. However, when cleaning fluid is ejected into a closed space, the adhering matter that has been removed from the nozzle to be cleaned is splashed around, and there is a possibility that it will adhere to the nozzle again.

Therefore, it is desired to develop a technology capable of effectively removing adhering matter adhering to a nozzle to be cleaned.

### BRIEF DESCRIPTION OF THE DRAWINGS

FIG. 1 is a schematic view illustrating a nozzle cleaning unit according to a first embodiment;

FIG. 2 is a schematic view illustrating the cleaning unit;

FIG. 3 is a schematic cross-sectional view illustrating a cleaning nozzle unit;

FIG. 4 is a schematic view illustrating an immersion unit;

FIG. 5 is a schematic cross-sectional view illustrating an immersion tank;

FIGS. 6A and 6B are schematic views illustrating a wiping unit;

FIG. 7 is a flowchart illustrating an action of the nozzle cleaning unit and the nozzle cleaning method;

FIG. 8 is a schematic view illustrating a nozzle cleaning unit according to a second embodiment;

FIG. 9 is a schematic view illustrating a cleaning unit;

FIG. 10 is a schematic cross-sectional view illustrating a cleaning nozzle unit; and

FIGS. 11A to 11E are schematic process views illustrating an action of the nozzle cleaning unit and the nozzle cleaning method.

### DETAILED DESCRIPTION

In general, according to one embodiment, a nozzle cleaning unit includes: a cleaning nozzle unit; a gas supply unit; and a regulator. The cleaning nozzle unit has a first ejection hole that opens in a ring shape to an inner wall surface of an insertion part into which the nozzle is inserted. The gas supply unit supplies gas to the first ejection hole. The regulator reduces a pressure of an atmosphere of the insertion part on a side opposite a side in which the nozzle is inserted, sandwiching a position where the first ejection hole is provided.

In general, according to another embodiment, a nozzle cleaning method, includes: ejecting gas toward a nozzle from a first ejection hole that opens in a ring shape to an inner wall surface of an insertion part into which the nozzle is inserted; and reducing a pressure of an atmosphere of the insertion part on a side opposite a side in which the nozzle is inserted, sandwiching a position where the first ejection hole is provided.

Embodiments will now be described with reference to the drawings. Note that the same numerals are applied to similar constituent elements in the drawings and detailed descriptions of such constituent elements are appropriately omitted.

### First Embodiment

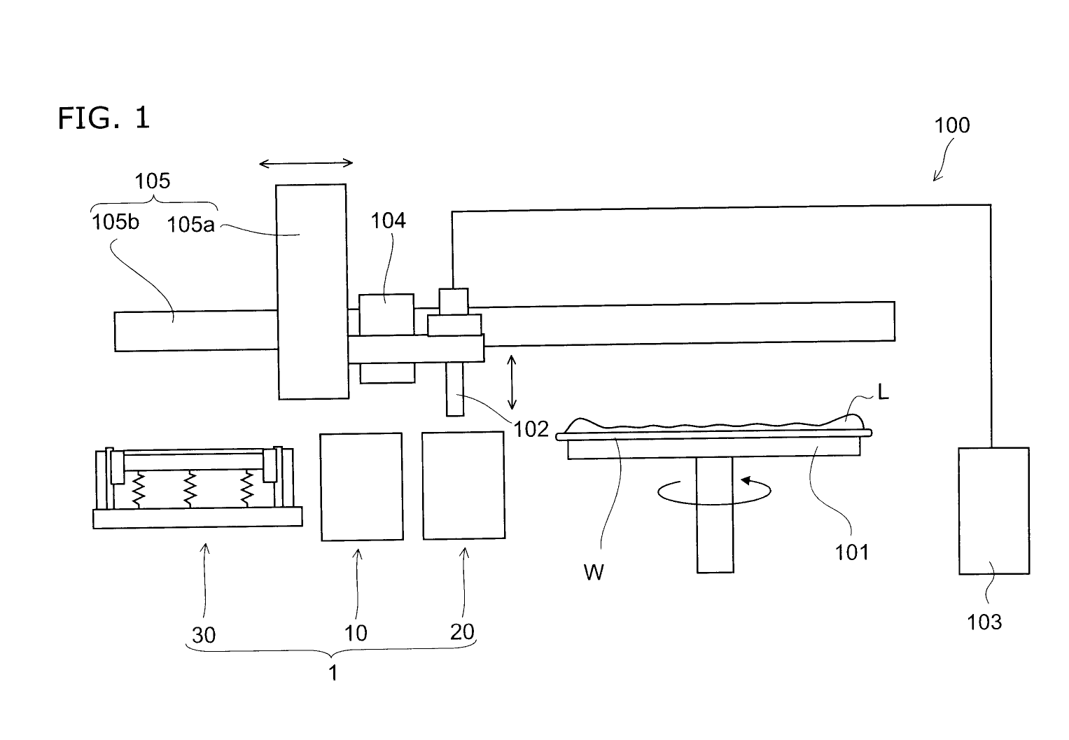

FIG. 1 is a schematic view illustrating a nozzle cleaning unit 1 according to the first embodiment. In FIG. 1, an application device 100 that includes a nozzle 102 to be cleaned is also illustrated as an example.

First, the application device 100 is described.

The application device 100 is provided with a stage 101, the nozzle 102, an application fluid supply unit 103, a detector 104, and a moving unit 105.

The stage 101 supports a substrate W placed on the stage 101. Also, the stage 101 is rotated in the horizontal plane by a drive unit not illustrated on the drawings. The substrate W can be supported by, for example, suction using a vacuum pump not illustrated on the drawings or the like.

The nozzle 102 ejects application fluid L toward the surface of the substrate W. The nozzle 102 ejects the application fluid L continuously, applying the application fluid L onto the surface of the substrate W. For example, the substrate W is a semiconductor wafer or the like, and the application fluid L is a resist fluid or the like.

The application fluid supply unit 103 supplies application fluid L to the surface of the substrate W via the nozzle 102. The application fluid supply unit 103 may include, for example, a tank that contains the application fluid L, a pump that supplies the application fluid L, a flow rate adjustment valve, an opening/closing valve, and the like.

The detector 104 detects the distance to the surface of the substrate W. The distance between the tip surface of the nozzle 102 and the surface of the substrate W is controlled by a control unit not illustrated on the drawings, based on the detected distance to the surface of the substrate W. The detector 104 may be a reflective laser sensor or the like.

The moving unit 105 includes an elevator 105a and a moving portion 105b. The elevator 105a supports the nozzle 102 and raises and lowers the nozzle 102. The moving portion 105b supports the elevator 105a, and moves the nozzle 102 in a direction perpendicular to the vertical direction. The moving unit 105 can be a 2 axis control robot or the like.

When application is carried out in such an application device 100, application fluid L can adhere to the tip portion of the nozzle 102. When application fluid L adheres to the tip portion of the nozzle 102, there is a possibility that the quantity applied to the surface of the substrate W will become unstable. For example, there is a possibility that the adhering application fluid L will be added to the application fluid L on the substrate W side, causing the applied quantity to be increased, or the application fluid L on the substrate W side will be drawn to the adhering application fluid L, causing the applied quantity to be decreased.

If a nozzle cleaning unit 1 according to this embodiment is provided, it is possible to effectively remove adhering application fluid L from the tip portion of the nozzle 102. Therefore, it is possible to stabilize the quantity applied to the surface of the substrate W.

Next, returning to FIG. 1, the nozzle cleaning unit 1 according to this embodiment is described. As illustrated in FIG. 1, the nozzle cleaning unit 1 is provided with a cleaning unit 10, an immersion unit 20, and a wiping unit 30.

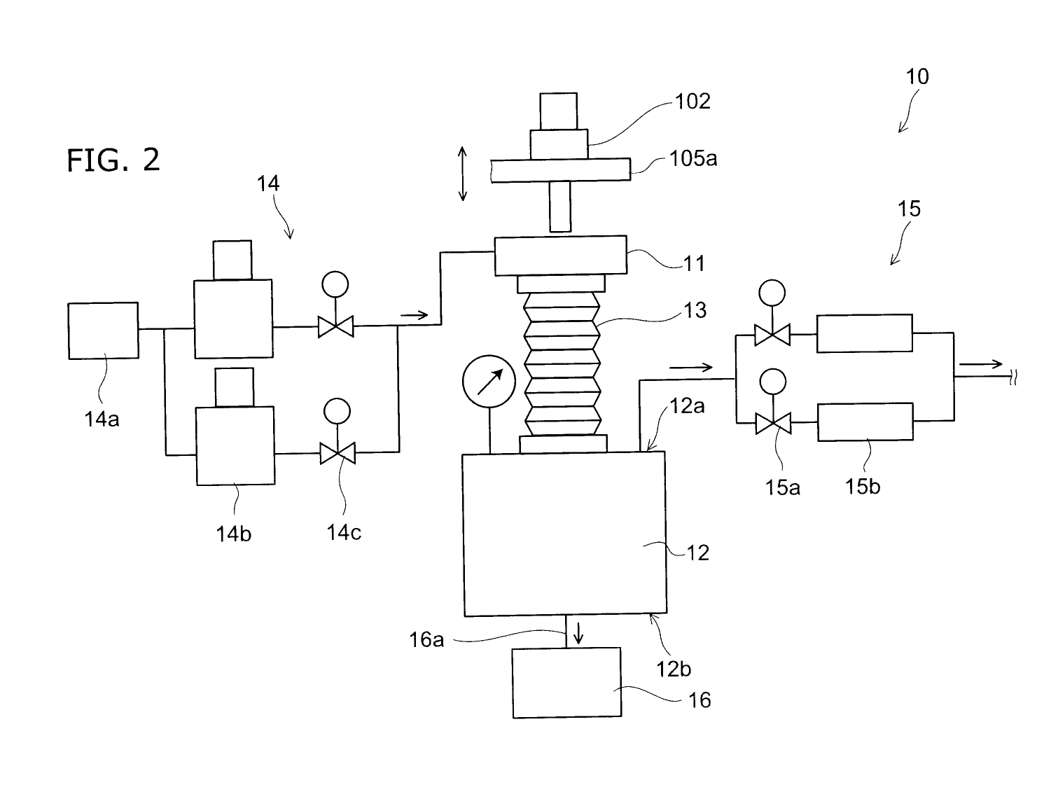

FIG. 2 is a schematic view illustrating the cleaning unit 10.

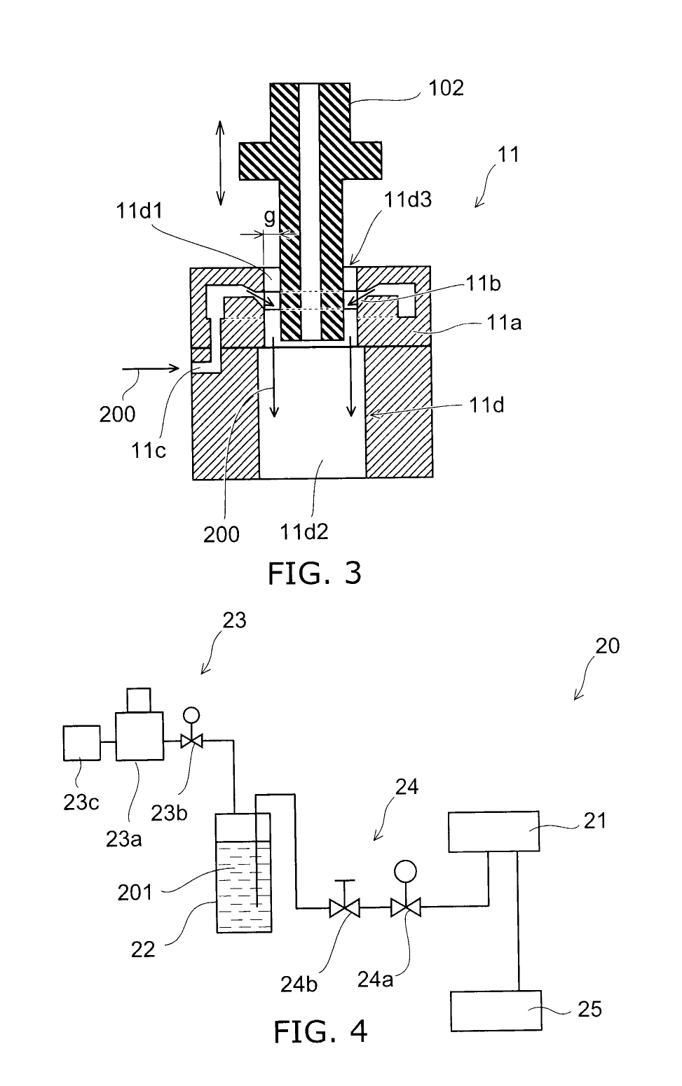

FIG. 3 is a schematic cross-sectional view illustrating a cleaning nozzle unit 11.

As illustrated in FIG. 2, the cleaning unit 10 is provided with the cleaning nozzle unit 11, a container 12, a connector 13, a gas supply unit 14, a regulator 15, and a recovery tank 16.

The cleaning nozzle unit 11 injects gas 200 toward the tip portion of the nozzle 102 to be cleaned. There is no particular limitation on the gas 200, for example, it can be air, nitrogen gas or the like.

As illustrated in FIG. 3, the cleaning nozzle unit 11 includes a main body part 11a, an ejection hole 11b (corresponding to one example of a first ejection hole), a supply hole 11c, and a cleaning hole 11d.

The main body part 11a has a cylindrical shape, having the cleaning hole 11d penetrating through the center in the axial direction. The ejection hole 11b opens in a ring shape to the inner wall surface of the cleaning hole 11d (insertion part 11d1). Therefore, it is possible to inject gas 200 around the whole periphery of the tip portion of the nozzle 102 that has been inserted into the insertion part 11d1.

Also, the ejection hole 11b is slanted toward a discharge part 11d2 side of the cleaning hole 11d. Therefore, the gas 200 ejected from the ejection hole 11b can easily flow toward the discharge part 11d2 side of the cleaning hole 11d.

The supply hole 11c opens to the external wall surface of the main body part 11a at a first end, and is connected to the ejection hole 11b at a second end.

The gas supply unit 14 is connected to the supply hole 11c.

The cleaning hole 11d includes the insertion part 11d1 and the discharge part 11d2.

A first end of the insertion part 11d1 opens to an end of the main body part 11a. The tip portion of the nozzle 102 to be cleaned is inserted into the insertion part 11d1. The cross-sectional dimensions of the insertion part 11d1 are greater than the cross-sectional dimensions of the tip portion of the nozzle 102. In this case, the gap g between the tip portion of the nozzle 102 and the inner wall surface of the insertion part 11d1 is made small so that the gas 200 ejected from the ejection hole 11b cannot easily leak to the outside from an aperture 11d3 of the insertion part 11d1.

A first end of the discharge part 11d2 is connected to the insertion part 11d1, and a second end opens to an end of the main body part 11a. The discharge part 11d2 is connected to the connector 13.

The cross-sectional dimensions of the discharge part 11d2 are greater than the cross-sectional dimensions of the insertion part 11d1, so that the gas 200 ejected from the ejection hole 11b can be easily discharged.

The container 12 has a box shape, and the top surface 12a is connected to the discharge part 11d2 side of the cleaning nozzle unit 11 via the connector 13.

Also, the regulator 15 is connected to the top surface 12a of the container 12, and the recovery tank 16 is connected to the bottom surface 12b of the container 12. Therefore, gas 200 which is light is discharged from the regulator 15, and adhering matter, cleaning fluid 201 and the like which is heavy can be discharged into the recovery tank 16.

The connector 13 connects the cleaning nozzle unit 11 and the container 12. The connector 13 can be, for example, a flexible pipe member such as a bellows pipe.

The gas supply unit 14 supplies the cleaning nozzle unit 11 with gas 200.

The gas supply unit 14 can be provided with a supply unit 14a, a pressure control unit 14b, and an opening/closing valve 14c.

The supply unit 14a can be a tank that contains high-pressure gas 200, factory piping, or the like.

The pressure control unit 14b controls the pressure of the gas 200 supplied from the supply unit 14a to be within a predetermined range.

The opening/closing valve 14c controls turning on and off the supply of gas 200.

In this case, a plurality of sets of pressure control unit 14b and opening/closing valve 14c can be provided. If a plurality of sets of pressure control unit 14b and opening/closing valve 14c is provided, it is possible to switch the flow rate of the ejected gas 200 in accordance with the viscosity and the like of the adhering matter adhering to the nozzle 102.

For example, for adhering matter with low viscosity, the gas 200 can be ejected via the pressure control unit 14b with a low pressure setting. Also, for adhering matter with high viscosity, the gas 200 can be ejected via the pressure control unit 14b with a high pressure setting. In this way, adhering matter with high viscosity can be easily removed, and it is possible to suppress splash of adhering matter with low viscosity.

The regulator 15 reduces the pressure of the atmosphere of the cleaning hole 11d on a side opposite a side in which the nozzle 102 is inserted, sandwiching the position where the ejection hole 11b is provided.

For example, the regulator 15 discharges the gas 200 from the cleaning nozzle unit 11 via the container 12 and the connector 13.

The regulator 15 can be provided with an opening/closing valve 15a and a gas discharge device 15b.

The opening/closing valve 15a controls turning on and off the discharge of the gas 200.

The gas discharge device 15b can be, for example, a vacuum ejector or the like.

In this case, a plurality of sets of opening/closing valve 15a and gas discharge device 15b can be provided. If a plurality of sets of opening/closing valve 15a and gas discharge device 15b is provided, it is possible to switch the quantity of discharged gas 200 to be discharged in accordance with the viscosity of the adhering matter adhering to the nozzle 102 and the like.

For example, for adhering matter with low viscosity, the gas 200 can be discharged via the gas discharge device 15b with the discharge quantity set low. Also, for adhering matter with high viscosity, the gas 200 can be discharged via the gas discharge device 15b with the discharge quantity set high. In this way, the energy efficiency can be improved.

The recovery tank 16 recovers the adhering matter, cleaning fluid 201 and the like.

The recovery tank 16 has a box shape, and is connected to the bottom surface 12b of the container 12 via a pipe 16a.

The cleaning unit 10 according to this embodiment includes the cleaning nozzle unit 11 that includes the ejection hole 11b that opens in a ring shape to the inner wall surface of the cleaning hole 11d (insertion part 11d1), and the regulator 15 that reduces the pressure of the atmosphere of the cleaning hole 11d on the side opposite the side in which the nozzle 102 is inserted, sandwiching the position where the ejection hole 11b is provided.

Therefore, it is possible to suppress the re-adhesion onto the nozzle 102 of the adhering matter splashed around after being removed from the nozzle 102 to be cleaned. As a result, it is possible to effectively remove the adhering matter adhering to the nozzle 102.

Also, the gap g is provided between the tip portion of the nozzle 102 and the inner wall surface of the insertion part 11d1. In other words, the cleaning hole 11d of the cleaning nozzle unit 11 is not closed. Therefore, the gas 200 can be efficiently discharged from the cleaning nozzle unit 11 by the regulator 15.

Next, the immersion unit 20 is described.

FIG. 4 is a schematic view illustrating the immersion unit 20.

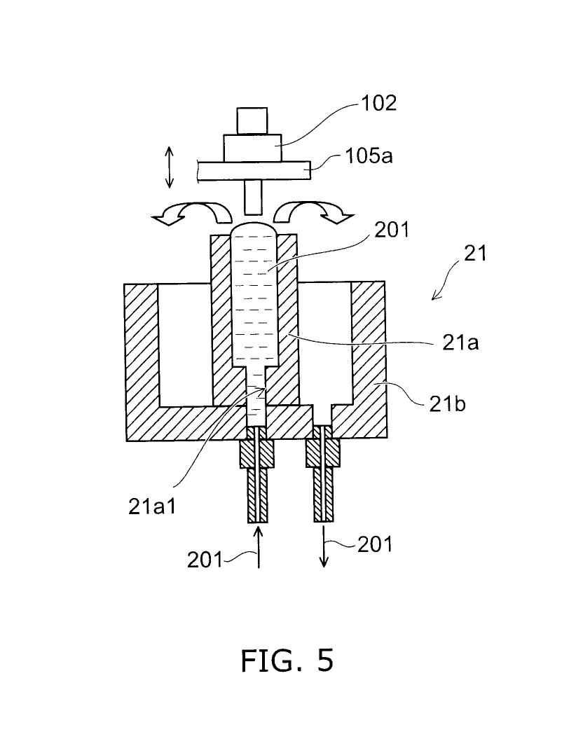

FIG. 5 is a schematic cross-sectional view illustrating an immersion tank 21.

As illustrated in FIG. 4, the immersion unit 20 includes the immersion tank 21, a housing unit 22, a fluid delivery unit 23, a flow rate control unit 24, and a waste liquid unit 25.

As illustrated in FIG. 5, the immersion tank 21 includes a cleaning tank 21a and a recovery tank 21b. By inserting the tip portion of the nozzle 102 to be cleaned into the cleaning tank 21a, the adhering matter is dissolved or removed.

The cleaning tank 21a has a cylindrical shape with a bottom. A supply hole 21a1 opens into the bottom face of the cleaning tank 21a. The supply hole 21a1 is connected to the housing unit 22 via the flow rate control unit 24. The position of the top end of the cleaning tank 21a is higher than the position of the top end of the recovery tank 21b. Therefore, cleaning fluid 201 supplied from the bottom face side of the cleaning tank 21a overflows from the top end side of the cleaning tank 21a, and can flow into the recovery tank 21b provided below. In this way, the nozzle 102 is always brought into contact with new cleaning fluid 201.

The recovery tank 21b has a cylindrical shape with a bottom. The cleaning tank 21a is provided inside the recovery tank 21b. The recovery tank 21b is connected to the waste liquid unit 25, and the cleaning fluid 201 that flows into the recovery tank 21b from the cleaning tank 21a is sent to the waste liquid unit 25.

The housing unit 22 contains the cleaning fluid 201.

There is no particular limitation on the cleaning fluid 201, and it can be selected as appropriate in accordance with the nature of the adhering matter. For example, if the adhering matter is resist, the cleaning fluid 201 can include a ketone solvent, an alcohol solvent or the like.

The fluid delivery unit 23 delivers the cleaning fluid 201 contained in the housing unit 22 under pressure to the immersion tank 21, by supplying gas into the housing unit 22.

The fluid delivery unit 23 includes a pressure control unit 23a, an opening/closing valve 23b, and a supply unit 23c.

The pressure control unit 23a controls the pressure of the gas supplied from the supply unit 23c into the housing unit 22. There is no particular limitation on the gas supplied from the supply unit 23c, for example, air, nitrogen gas or the like can be used.

The opening/closing valve 23b turns on and off the supply of gas to the housing unit 22.

The supply unit 23c can be a tank that contains high-pressure gas, factory piping, or the like.

The flow rate control unit 24 includes a flow rate adjustment valve 24a and an opening/closing valve 24b.

The flow rate adjustment valve 24a adjusts the flow rate of the cleaning fluid 201 supplied into the cleaning tank 21a.

The opening/closing valve 24b turns on and off the supply of cleaning fluid 201 to the cleaning tank 21a.

In this embodiment, the housing unit 22, the fluid delivery unit 23, and the flow rate control unit 24 form a cleaning fluid supply unit (corresponding to one example of a second cleaning fluid supply unit) that supplies cleaning fluid to the cleaning tank 21a.

The waste liquid unit 25 has a box shape, and contains the cleaning fluid 201 flowed from the immersion tank 21.

According to the immersion unit 20 of this embodiment, it is possible to always bring new cleaning fluid 201 into contact with the nozzle 102 to be cleaned. Therefore, it is possible to effectively remove or dissolve adhering matter adhering to the nozzle 102.

Next, the wiping unit 30 is described.

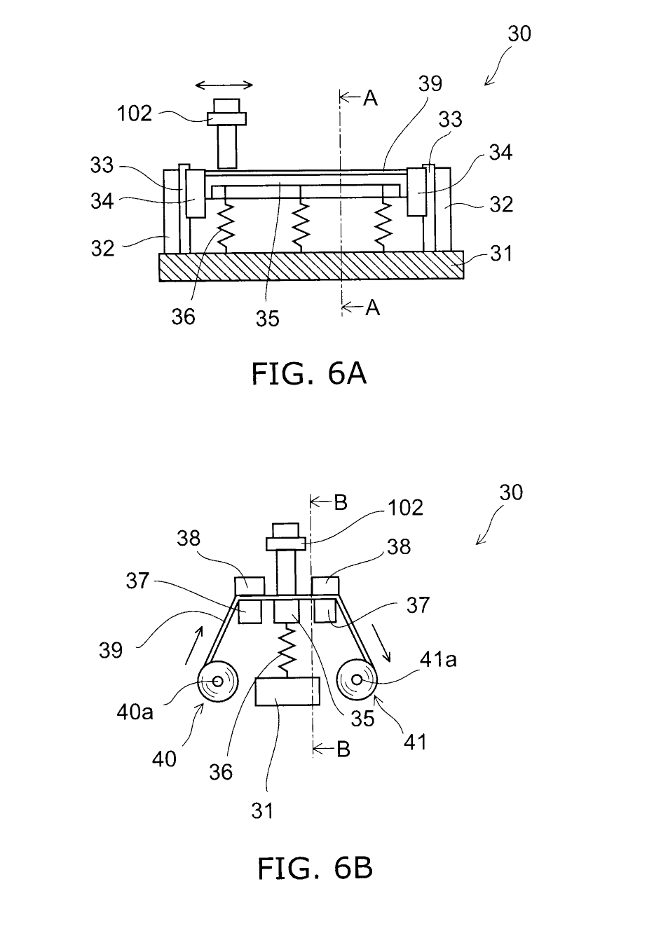

FIGS. 6A and 6B are schematic views illustrating the wiping unit 30.

FIG. 6A is a cross-sectional view at the line B-B in FIG. 6B, and FIG. 6B is a cross-sectional view at the line A-A in FIG. 6A.

As illustrated in FIGS. 6A and 6B, the wiping unit 30 is provided with a base 31, a support 32, a guide unit 33, a retention unit 34, a pad 35, an elastic member 36, a support plate 37, a retaining plate 38, a cloth 39, a supply unit 40, and a winding unit 41.

The base 31 has a plate shape, and is provided between the supply unit 40 and the winding unit 41.

The support 32 is provided at each of both ends of the base 31 in the longitudinal direction. The support 32 has a prismoidal shape.

The guide unit 33 is provided on the support 32. The guide unit 33 extends in the axial direction of the support 32.

The retention unit 34 retains the pad 35, and moves along the guide unit 33.

The pad 35 contacts the opposite side of the cloth 39 to the side that contacts the tip surface of the nozzle 102. The pad 35 has a plate shape, and is retained at both ends by the retention unit 34.

The longitudinal direction of the pad 35 is the same as the longitudinal direction of the base 31.

The elastic member 36 is provided between the base 31 and the pad 35, and impels the pad 35 toward the cloth 39. The elastic member 36 can be, for example, a compression spring or the like.

The support plate 37 contacts the opposite side of the cloth 39 to the side that contacts the tip surface of the nozzle 102. Two support plates 37 are provided sandwiching the pad 35 in the direction perpendicular to the longitudinal direction of the pad 35. The support plate 37 is retained by, for example, the support 32.

The retaining plate 38 is provided above each of the two support plates 37. In other words, the retaining plate 38 is provided opposite the support plate 37 sandwiching the cloth 39. The retaining plate 38 is impelled toward the support plate 37 by an elastic member not illustrated on the drawings.

The case in which two sets of the support plate 37 and the retaining plate 38 are provided has been described, but the number of sets can be changed as appropriate. For example, one set of support plate 37 and retaining plate 38 may be provided, or three or more sets may be provided.

The cloth 39 has a band shape. A first end of the cloth 39 is retained on a winding core 40a of the supply unit 40, and a second end is retained on a winding core 41a of the winding unit 41.

The cloth 39 passes between the support plate 37 and the retaining plate 38 on the supply unit 40 side, over the top surface of the pad 35, and between the support plate 37 and the retaining plate 38 on the winding unit 41 side.

The tip surface of the nozzle 102 can be wiped by bringing the tip surface of the nozzle 102 to be cleaned into contact with the cloth 39, and moving it over the cloth 39 while maintaining contact. In this case, the cloth 39 is pressed against the tip surface of the nozzle 102 as a result of the action of the elastic member 36 via the pad 35. As a result, it is possible to maintain close contact between the cloth 39 and the tip surface of the nozzle 102.

The supply unit 40 supports the winding core 40a on which the cloth 39 is wound. Also, the winding core 40a can rotate.

The winding unit 41 supports the winding core 41a. Also, the winding core 41a is rotated by a drive device not illustrated on the drawings to wind the cloth 39.

In the wiping unit 30 according to this embodiment, the cloth 39 is sandwiched by the support plate 37 and the retaining plate 38.

Therefore, even if the position of the pad 35 moves downwards when pressed by the nozzle 102, it is possible to suppress any bending of the cloth 39 between the supply unit 40 side and the winding unit 41 side. Therefore, it is possible to more effectively remove the adhering matter adhering to the nozzle 102.

Next, the action of the nozzle cleaning unit 1 together with the nozzle cleaning method according to this embodiment are described.

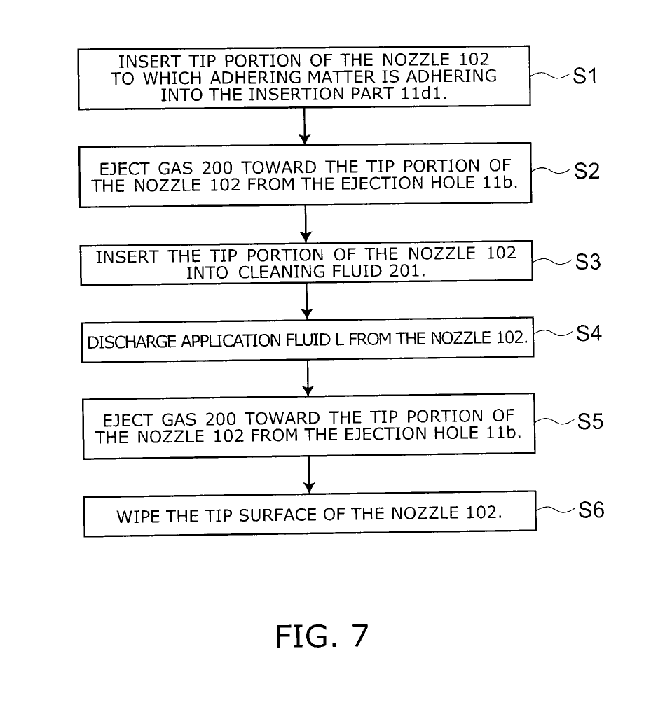

FIG. 7 is a flowchart illustrating the action of the nozzle cleaning unit 1 and the nozzle cleaning method.

As illustrated in FIG. 7, first, the tip portion of the nozzle 102 on which adhering matter is adhering is inserted into the insertion part 11d1 (step S1).

For example, the nozzle 102 on which adhering matter is adhering is moved above the cleaning nozzle unit 11 by the moving unit 105, then, the tip portion of the nozzle 102 is inserted into the insertion part 11d1 of the cleaning hole 11d.

Next, gas 200 is ejected onto the tip portion of the nozzle 102 from the ejection hole 11b (step S2).

At this time, the regulator 15 reduces the pressure of the atmosphere of the cleaning hole 11d on the side opposite the side in which the nozzle 102 is inserted, sandwiching the position where the ejection hole 11b is provided. In other words, the pressure of the discharge part 11d2 side of the cleaning hole 11d is reduced by the regulator 15.

Next, the tip portion of the nozzle 102 is placed in cleaning fluid 201 (step S3). For example, the nozzle 102 is moved above the cleaning tank 21a by the moving unit 105, then, the tip portion of the nozzle 102 is inserted into the cleaning fluid 201 of the cleaning tank 21a.

Next, the application fluid L is discharged from the nozzle 102 (step S4).

By inserting the tip portion of the nozzle 102 in the cleaning fluid 201, the cleaning fluid 201 becomes mixed with the application fluid L on the tip portion of the nozzle 102. Therefore, the application fluid L mixed with the cleaning fluid 201 is discharged.

For example, the nozzle 102 is moved above the cleaning nozzle unit 11 by the moving unit 105, then, the tip portion of the nozzle 102 is inserted into the insertion part 11d1. Then, the application fluid L is discharged from the nozzle 102.

Next, gas 200 is ejected onto the tip portion of the nozzle 102 from the ejection hole 11b (step S5).

At this time, the pressure at the discharge part 11d2 of the cleaning hole 11d is reduced by the regulator 15.

Next, the tip surface of the nozzle 102 is wiped (step S6).

For example, the nozzle 102 is moved above the wiping unit 30 by the moving unit 105, then, the tip surface of the nozzle 102 is brought into contact with the cloth 39, and moved above the cloth 39, thereby wiping the tip surface of the nozzle 102.

As described above, the nozzle cleaning method according to this embodiment can include the following processes: a process of ejecting gas 200 onto the nozzle 102 from the ejection hole 11b that opens in a ring shape to the inner wall surface of the cleaning hole 11d into which the nozzle 102 is inserted; and a process of reducing the pressure of the atmosphere of the cleaning hole 11d on the side opposite the side in which the nozzle 102 is inserted, sandwiching the position where the ejection hole 11b is provided.

### Second Embodiment

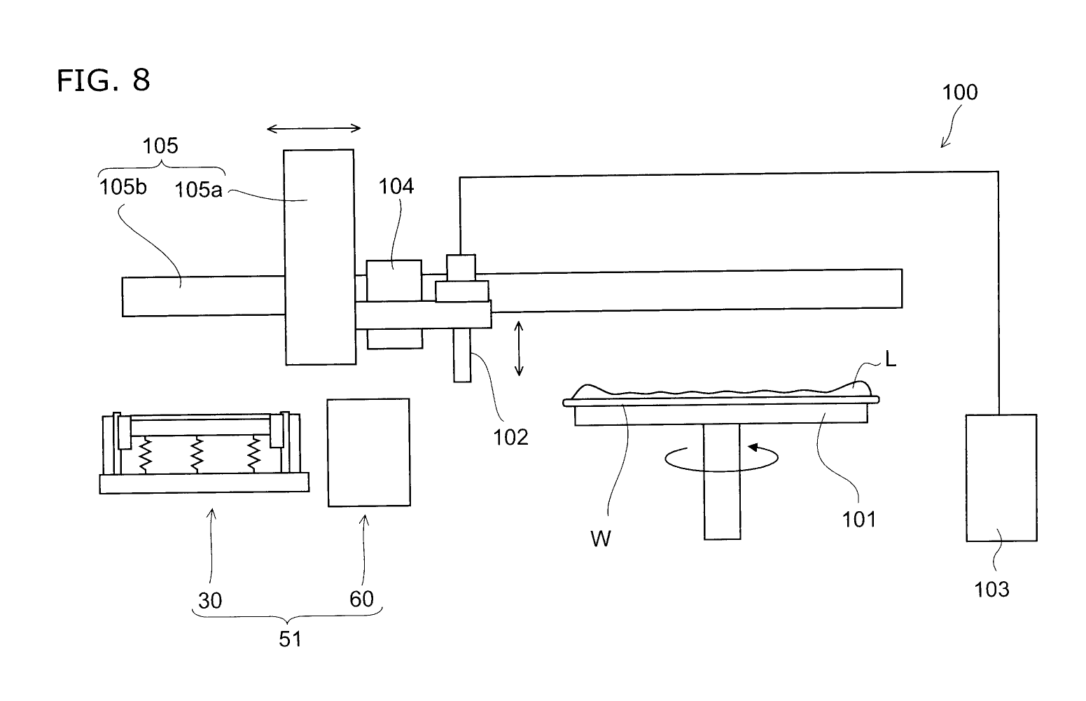

FIG. 8 is a schematic view illustrating a nozzle cleaning unit 51 according to the second embodiment.

In FIG. 8, the application device 100 that includes the nozzle 102 to be cleaned is also illustrated as an example.

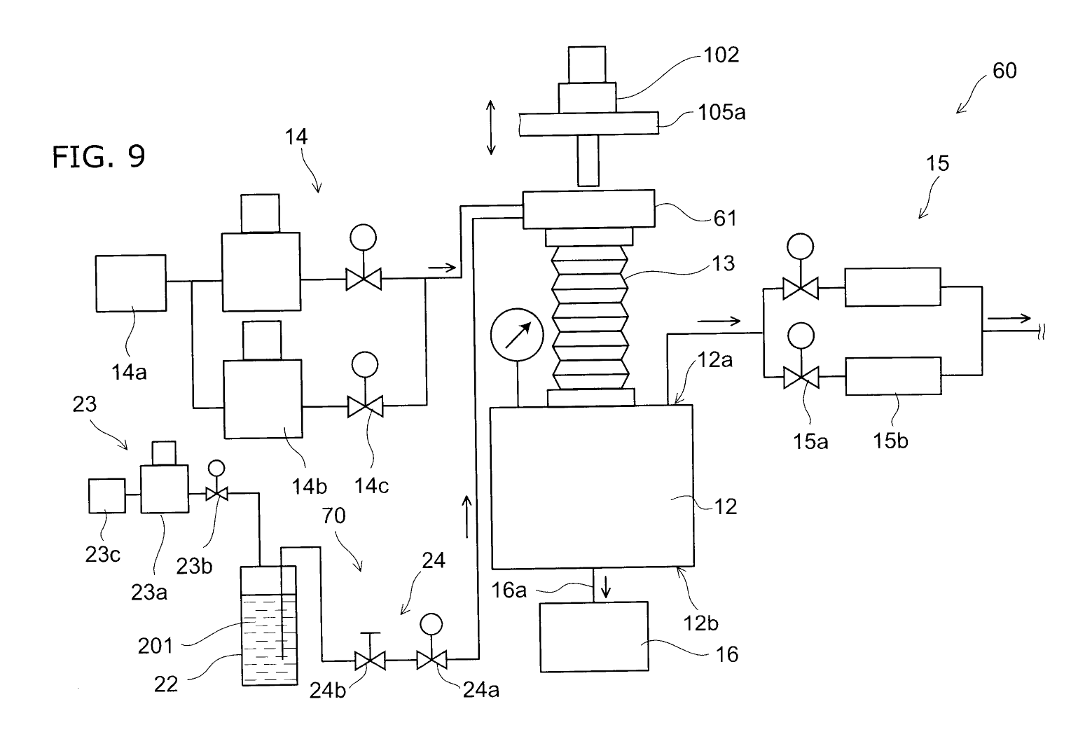

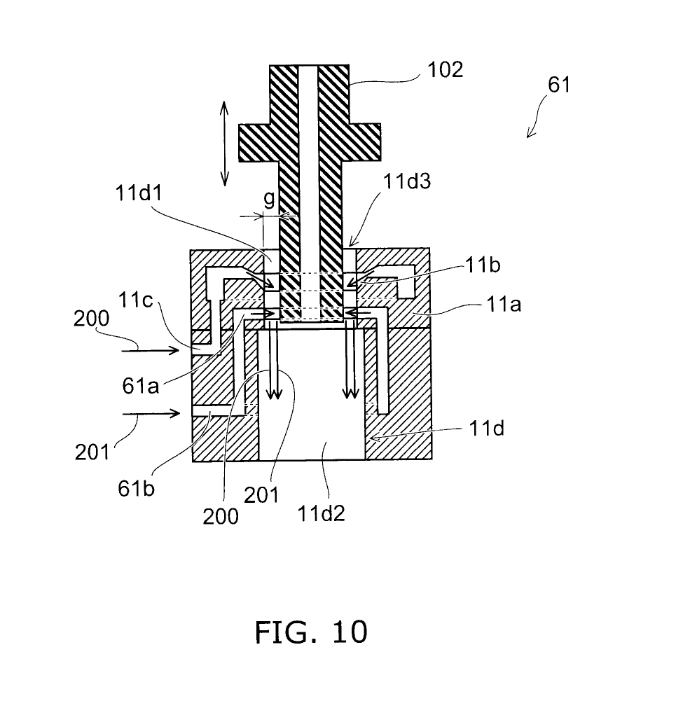

FIG. 9 is a schematic view illustrating a cleaning unit 60. FIG. 10 is a schematic cross-sectional view illustrating a cleaning nozzle unit 61.

As illustrated in FIG. 8, the nozzle cleaning unit 51 is provided with the cleaning unit 60, and the wiping unit 30.

As illustrated in FIG. 9, the cleaning unit 60 is provided with the cleaning nozzle unit 61, the container 12, the connector 13, the gas supply unit 14, the regulator 15, a cleaning fluid supply unit 70 (corresponding to one example of a first cleaning fluid supply unit), and the recovery tank 16.

The cleaning fluid supply unit 70 is provided with the housing unit 22, the fluid delivery unit 23, and the flow rate control unit 24.

The fluid delivery unit 23 delivers the cleaning fluid 201 contained in the housing unit 22 under pressure to the cleaning nozzle unit 61, by supplying gas into the housing unit 22.

In other words, the cleaning fluid supply unit 70 supplies cleaning fluid 201 to an ejection hole 61a (corresponding to one example of a second ejection hole).

As illustrated in FIG. 10, the cleaning nozzle unit 61 includes the main body part 11a, the ejection hole 11b, the supply hole 11c, the cleaning hole 11d, the ejection hole 61a, and a supply hole 61b. The ejection hole 61a opens in a ring shape to the inner wall surface of the cleaning hole 11d (insertion part 11d1). Therefore, cleaning fluid 201 can be ejected toward the whole periphery of the tip portion of the nozzle 102 inserted in the insertion part 11d1.

The supply hole 61b opens to the external wall surface of the main body part 11a at a first end, and is connected to the ejection hole 61a at a second end.

The cleaning fluid supply unit 70 is connected to the supply hole 61b.

In other words, the immersion unit 20 is not provided in the nozzle cleaning unit 51. Instead, the cleaning fluid supply unit 70 is provided, and the cleaning fluid 201 is ejected toward the tip portion of the nozzle 102 in the insertion part 11d1 of the cleaning nozzle unit 61.

The ejected cleaning fluid 201 flows into the recovery tank 16 via the container 12.

The cleaning unit 60 according to this embodiment includes the cleaning nozzle unit 61 which includes the ejection hole 11b and the ejection hole 61a that open in a ring shape to the inner wall surface of the cleaning hole 11d (insertion part 11d1), and the regulator 15 described above.

Therefore, it is possible to suppress the re-adhesion onto the nozzle 102 of the adhering matter splashed around after being removed from the nozzle 102 to be cleaned. As a result, it is possible to effectively remove the adhering matter adhering to the nozzle 102.

Also, the gap g is provided between the tip portion of the nozzle 102 and the inner wall surface of the insertion part 11d1. In other words, the cleaning hole 11d of the cleaning nozzle unit 61 is not closed. Therefore, the gas 200 can be efficiently discharged from the cleaning nozzle unit 61 by the regulator 15.

Also, when the nozzle 102 is cleaned, adhering matter can adhere to the inside of the cleaning hole 11d. When adhering matter adheres to the inside of the cleaning hole 11d, it is possible to clean the inside of the cleaning hole 11d by ejecting cleaning fluid 201 from the ejection hole 61a.

Next, the action of the nozzle cleaning unit 51 together with the nozzle cleaning method according to this embodiment are described.

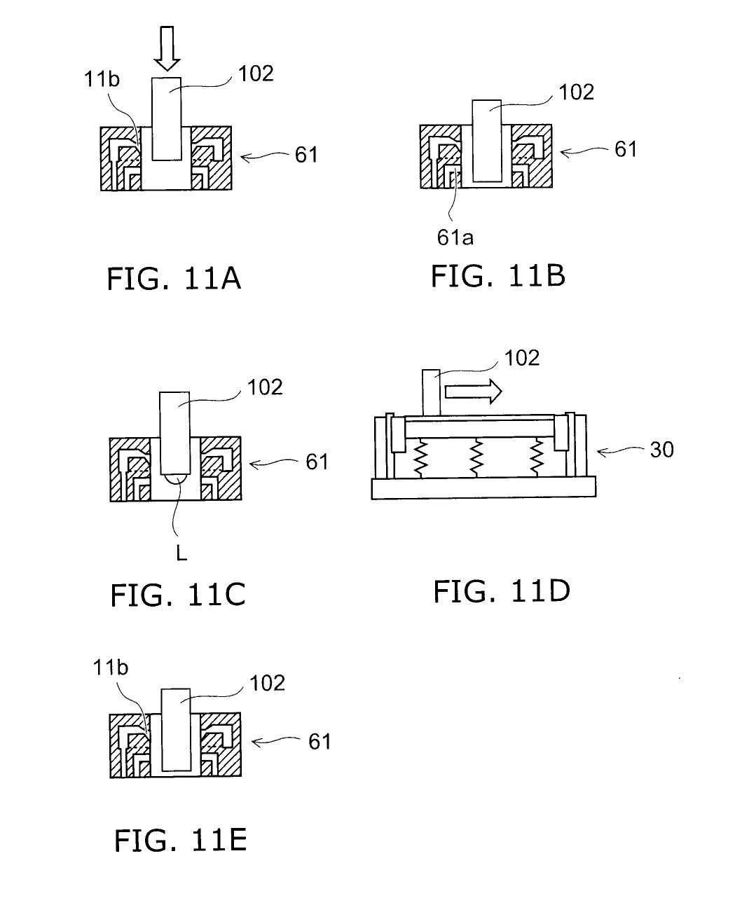

FIGS. 11A to 11E are schematic process views illustrating the action of the nozzle cleaning unit 51 and the nozzle cleaning method.

As illustrated in FIG. 11A, first, the tip portion of the nozzle 102 on which adhering matter is adhering is inserted into the insertion part 11d1 (step S11).

For example, the nozzle 102 on which adhering matter is adhering is moved above the cleaning nozzle unit 61 by the moving unit 105, then, the tip portion of the nozzle 102 is inserted into the insertion part 11d1.

Next, gas 200 is ejected onto the tip portion of the nozzle 102 from the ejection hole 11b. At this time, the pressure at the discharge part 11d2 side of the cleaning hole 11d is reduced by the regulator 15.

Next, as illustrated in FIG. 11B, cleaning fluid 201 is ejected toward the tip portion of the nozzle 102 from the ejection hole 61a (step S12).

At this time, the pressure at the discharge part 11d2 side of the cleaning hole 11d is reduced by the regulator 15. In this way, it is possible to suppress the leakage of cleaning fluid 201 to the outside from the aperture 11d3 of the insertion part 11d1.

Next, as illustrated in FIG. 11C, the application fluid L is discharged from the nozzle 102 (step S13).

When the cleaning fluid 201 is ejected toward the tip portion of the nozzle 102, the application fluid L on the tip portion of the nozzle 102 may be mixed with the cleaning fluid 201. Therefore, the cleaning fluid 201 that may be mixed with application fluid L is discharged.

Next, gas 200 is ejected onto the tip portion of the nozzle 102 from the ejection hole 11b. At this time, the pressure at the discharge part 11d2 side of the cleaning hole 11d is reduced by the regulator 15.

Next, as illustrated in FIG. 11D, the tip surface of the nozzle 102 is wiped (step S14). For example, the nozzle 102 is moved above the wiping unit 30 by the moving unit 105, then, the tip surface of the nozzle 102 is brought into contact with the cloth 39, and moved above the cloth 39 while maintaining contact, thereby wiping the tip surface of the nozzle 102.

Next, as illustrated in FIG. 11E, the gas 200 is ejected toward the tip portion of the nozzle 102 from the ejection hole 11b.

For example, the nozzle 102 is moved above the cleaning nozzle unit 61 by the moving unit 105, then, the tip portion of the nozzle 102 is inserted into the insertion part 11d1. Next, gas 200 is ejected into the tip portion of the nozzle 102 from the ejection hole 11b. At this time, the pressure at the discharge part 11d2 side of the cleaning hole 11d is reduced by the regulator 15. By ejecting gas 200 toward the tip portion of the nozzle 102 from the ejection hole 11b, the tip portion of the nozzle 102 is dried.

As described above, the nozzle cleaning method according to this embodiment can include the following processes:

a process of ejecting gas 200 onto the nozzle 102 from the ejection hole 11b that opens in a ring shape to the inner wall surface of the cleaning hole 11d into which the nozzle 102 is inserted; a process of reducing the pressure of the atmosphere of the cleaning hole 11d on the side opposite the side in which the nozzle 102 is inserted, sandwiching the position where the ejection hole 11b is provided; and

a process of ejecting cleaning fluid 201 toward the nozzle 102 from the ejection hole 61a that opens in a ring shape to the inner wall surface of the cleaning hole 11d into which the nozzle 102 is inserted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A nozzle cleaning unit, comprising:
a cleaning nozzle unit having a first ejection hole that opens in a ring shape to an inner wall surface of an insertion part into which the nozzle is inserted;
a gas supply unit supplying gas to the first ejection hole; and
a regulator reducing a pressure of an atmosphere of the insertion part on a side opposite a side in which the nozzle is inserted, sandwiching a position where the first ejection hole is provided.

2. The nozzle cleaning unit according to claim 1, wherein the cleaning nozzle unit further includes a second ejection hole that opens in a ring shape to the inner wall surface of the insertion unit, and
further comprising a first cleaning fluid supply unit that supplies cleaning fluid to the second ejection hole.

3. The nozzle cleaning unit according to claim 1, further comprising: an immersion unit that includes an immersion tank into which the nozzle is inserted, and
a second cleaning fluid supply unit that supplies cleaning fluid to the immersion tank.

4. The nozzle cleaning unit according to claim 1, further comprising a wiping unit that includes a cloth that contacts the tip surface of the nozzle,
a pad that contacts the opposite side of the cloth to the side that contacts the tip surface of the nozzle,
an elastic member that impels the pad toward the cloth,
a support plate that contacts the opposite side of the cloth to the side that contacts the tip surface of the nozzle, and
a retaining plate provided opposite the support plate so as to sandwich the cloth.

5. The nozzle cleaning unit according to claim 1, wherein the cleaning nozzle unit is connected to the insertion part, and has a discharge part that has cross-sectional dimensions greater than the cross-sectional dimensions of the insertion part.

6. The nozzle cleaning unit according to claim 5, wherein the first ejection hole is slanted toward the discharge part side.

7. The nozzle cleaning unit according to claim 5, further comprising a box-shaped container, wherein
the discharge part and the regulator are connected to the top surface of the container.

8. The nozzle cleaning unit according to claim 7, further comprising a recovery tank connected to the bottom surface of the container.

9. The nozzle cleaning unit according to claim 7, further comprising a connector that has flexibility, and that connects the top surface of the container and the discharge part.

10. The nozzle cleaning unit according to claim 1, further comprising a pressure control unit that controls the pressure of gas supplied to the first ejection hole.

11. The nozzle cleaning unit according to claim 10, further comprising an opening/closing valve that controls turning on and off the supply of gas to be supplied to the first ejection hole.

12. The nozzle cleaning unit according to claim 11, wherein a plurality of sets of the pressure control unit and the opening/closing valve is provided.

13. The nozzle cleaning unit according to claim 1, wherein the regulator has a plurality of sets of the opening/closing valve and a discharge device.

14. The nozzle cleaning unit according to claim 4, wherein the wiping unit further includes a supply unit and a winding unit, and
a first end of the cloth is retained in a winding core of the supply unit, and a second end is retained in a winding core of the winding unit.

15. A nozzle cleaning method, comprising:
ejecting gas toward a nozzle from a first ejection hole that opens in a ring shape to an inner wall surface of an insertion part into which the nozzle is inserted; and
reducing a pressure of an atmosphere of the insertion part on a side opposite a side in which the nozzle is inserted, sandwiching a position where the first ejection hole is provided.

16. The nozzle cleaning method according to claim 15, further comprising ejecting cleaning fluid toward the nozzle from a second ejection hole that opens in a ring shape to the inner wall surface of the insertion part.

17. The nozzle cleaning method according to claim 16, further comprising discharging application fluid mixed with the cleaning fluid from the inside of the nozzle.

18. The nozzle cleaning method according to claim 15, further comprising inserting the nozzle into cleaning fluid in an immersion tank.

19. The nozzle cleaning method according to claim 18, further comprising discharging application fluid mixed with the cleaning fluid from the inside of the nozzle.

20. The nozzle cleaning method according to claim 15, further comprising bringing the tip surface of the nozzle into contact with a cloth, and moving the nozzle on the cloth while maintaining contact.
